(19) United States
(12) Patent Application Publication
(10) Pub. No.: US 2015/0149373 A1
(43) Pub. Date: May 28, 2015

(54) Brand Scoring for Social Media Users

(71) Applicant: ADOBE SYSTEMS INCORPORATED, San Jose, CA (US)

(72) Inventors: Niyati Himanshu Chhaya, Nagar (IN); Sameer Kumar Agrawal, Patna (IN); Vikram Singh Rathore, Kota (IN); Tushar Mehndiratta, Rajpura (IN)

(73) Assignee: ADOBE SYSTEMS INCORPORATED, San Jose, CA (US)

(21) Appl. No.: 14/092,353

(22) Filed: Nov. 27, 2013

(51) Int. Cl. G06Q 30/02; G06Q 50/00

(52) U.S. Cl. CPC G06Q 30/0282; G06Q 50/01
USPC 705/319

(57) ABSTRACT

Techniques for brand scoring for social media users are described. In at least some embodiments, brand-related content that users post to a social media environment (e.g., social media website(s)) is identified and characterized. Based on attributes of a user and brand-related content posted by the user, a brand score for the user may be calculated. In at least some embodiments, a user's brand score provides an indication of the user's perception of a brand and/or the user's influence on perception of the brand in a social media environment.

### BACKGROUND

Social media platforms present an increasingly popular way for individuals to interact via the Internet. For instance, a user typically sets up an account that uniquely identifies the user on a particular social media platform. Using the account, the user may post various types of content, such as comments (e.g., “status updates”), photos, video, links to websites of interest, and so forth. Further, a user may have accounts with multiple different platforms, and can post content to the different platforms using the different accounts. For instance, a particular platform may be better suited for posting a specific type of content than another platform. Thus, a user's collection of accounts with different social media platforms represents the user's presence in an overall social media environment.

Social media not only provides a means for individuals to interact, it also provides an opportunity to gather various types of information about users. For instance, marketers can monitor social media platforms to determine user interest in various products, services, and so on. This enables marketers to focus promotions on users who may have interest in particular products or services that are being promoted. Due to the sheer amount of data available from different social platforms, however, determining preferences of specific users can be challenging.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for brand scoring for social media users are described. In at least some embodiments, brand-related content that users post to a social media environment (e.g., social media website(s)) is identified and characterized. Based on attributes of a user and brand-related content posted by the user, a brand score for the user may be calculated. In at least some embodiments, a user's brand score provides an indication of the user's perception of a brand and/or the user's influence on perception of the brand in a social media environment.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein in accordance with one or more embodiments.

FIG. 2 is a flow diagram that describes steps in a general method for calculating a brand score for a user in accordance with one or more embodiments.

FIG. 3 is a flow diagram that describes steps in a detailed method for calculating a brand score for a user in accordance with one or more embodiments.

FIG. 4 is a flow diagram that describes steps in a detailed method for quantifying a user's brand-related activity in accordance with one or more embodiments.

FIG. 5 illustrates an example brand score graph in accordance with one or more embodiments.

FIG. 6 illustrates an example user detail graphical user interface in accordance with one or more embodiments.

FIG. 7 illustrates an example system and computing device as described with reference to FIG. 1, which are configured to implement embodiments of techniques described herein.

### DETAILED DESCRIPTION

Overview

Techniques for brand scoring for social media users are described. Generally, a “brand” refers to an identifier for a particular product and/or service. Examples of brands include product names, service identifiers, manufacturer names, trademarks, service marks, and so forth. A person's name may also be considered a brand, such as for celebrities, sports stars, artists, and so forth. Thus, a brand provides a means of identifying and distinguishing a product, service, and/or person from others.

In at least some embodiments, brand-related content that users post to a social media environment (e.g., social media website(s)) is identified and characterized. For instance, the brand-related content can be identified based on keyword detection from social media posts, such as based on various pre-defined keywords. The brand-related content can be characterized based on “sentiment” associated with the content. For instance, keywords in the brand-related content may be detected that indicate a particular sentiment between the user and the brand. For instance, some keywords may indicate that a user has a positive sentiment toward a brand, such as “like,” “cool,” “awesome,” and so forth. Other keywords may indicate that a user has a negative sentiment toward a brand, such as “terrible,” “fail,” “junk,” and so forth.

Based on attributes of a user and brand-related content posted by the user, a brand score for the user may be calculated. For instance, a user's influence in a social media environment can be quantified, such as based on a number of friends and followers that the user has, how much of the user's social media content is re-shared by other users, and so forth. Further, brand-related social media content that the user posts can be quantified, such as based on an amount of the content and sentiment values for the content. Values determined for the user's influence and for the user's brand-related social media content can be used to calculate a brand score for the user. Example ways of calculating a brand score are detailed below.

In at least some embodiments, a user's brand score provides an indication of the user's perception of a brand and/or the user's influence on perception of the brand in a social media environment. For instance, a high brand score may indicate that the user is a brand promoter, e.g., that the user generally has a positive sentiment toward the brand. On the other hand, a low brand score may indicate that the user is a brand detractor, e.g., that the user has a negative sentiment toward the brand. Based on whether a user is classified as a brand promoter or a brand detractor, a brand-related entity can focus various brand efforts, such as advertising, product promotions, and so forth.

In the following discussion, an example environment is first described that is operable to employ techniques described herein. Next, a section entitled “Example Procedures” describes some example methods for brand scoring for social media users in accordance with one or more embodiments. Following this, a section entitled “Calculating Brand Score” describes a detailed way of calculating a brand score in accordance with one or more embodiments. Next, a section entitled “Example Implementation Scenarios” describes some example implementation scenarios for brand scoring for social media users in accordance with one or more embodiments. Finally, a section entitled “Example System and Device” describes an example system and device that are operable to employ techniques discussed herein in accordance with one or more embodiments.

Example Environment

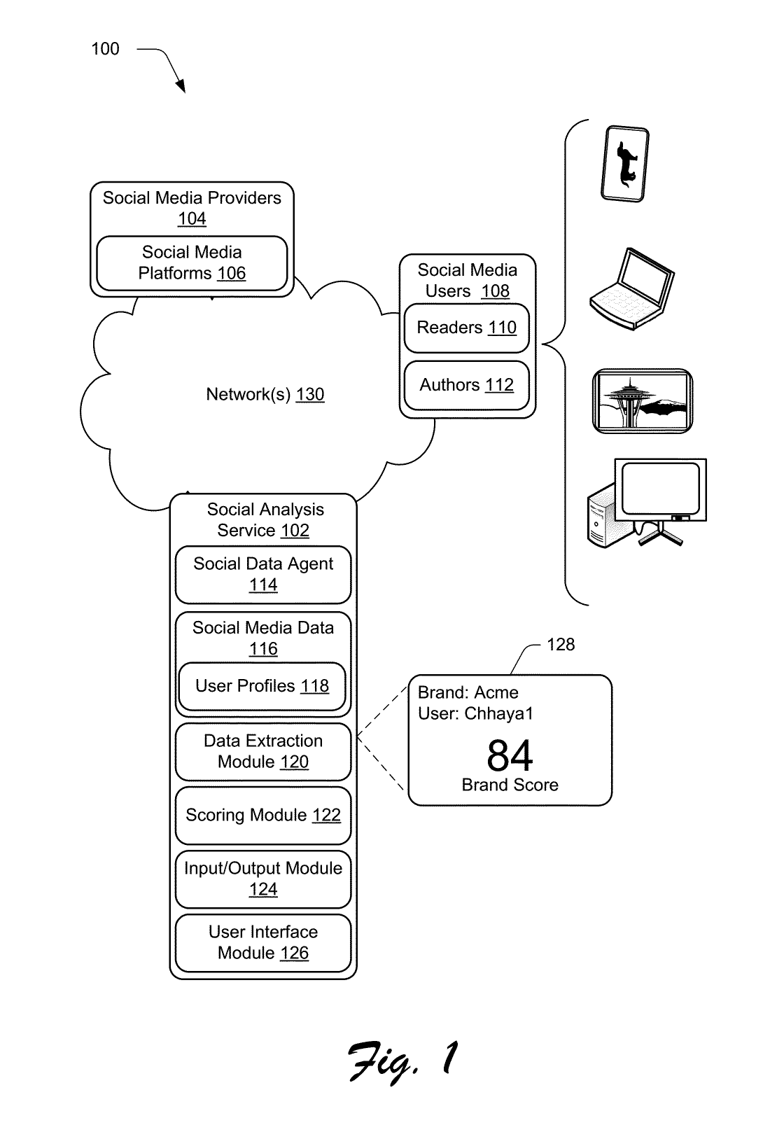

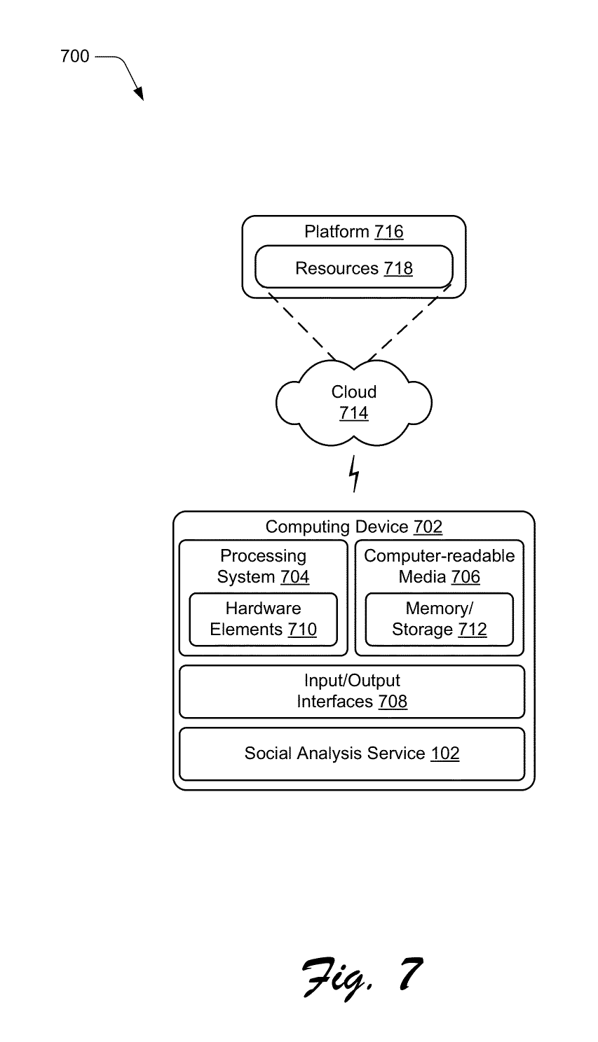

FIG. 1 is an illustration of an environment 100 in an example implementation that is operable to employ techniques for brand scoring for social media users discussed herein. Environment 100 includes a social analysis service 102, which is representative functionality to process social media data, such as to perform various techniques discussed herein. The social analysis service 102 can be leveraged by various entities, such as advertisers, promoters, product developers, and so forth. The social analysis service 102 can be implemented in a variety of ways, such as a distributed application (e.g., a web app), a local application, and/or combinations thereof. Further, the social analysis service 102 can be implemented via various types and/or combinations of computing devices, examples of which are described below in FIG. 7.

The environment 100 further includes social media providers 104, which are representative of various enterprises and/or services that provide social media platforms 106 via which different users may interact and communicate. For instance, the social media platforms 106 can include web-based portals for social interaction. At least some of the social media platforms 106, for instance, can include webpages and/or web apps that enable users to view and post social media content.

Social media users 108 are illustrated, which are representative of users which may interact via the social media platforms 106. For instance, the social media users 108 create accounts with the different social media platforms 106. Utilizing the accounts, the social media users 108 can post various types of content to the social media platforms 106, such as text content (e.g., messages), photographs, video, audio, and so on. The social media users 108 can also utilize the social media platforms 106 to demonstrate an affinity for various content and/or entities, such as by indicating a preference (e.g., “liking”) for a particular instance of content, “friending” other users, following other users, and so on.

Included as part of the social media users 108 are two general categories of users, readers 110 and authors 112. The readers 110 are representative of users that primarily consume social media content, such as by visiting various of the social media platforms 106 to view content. The authors 112 are representative of users that post content to the social media platforms 106.

While it is the case that many of the social media users 108 will be both a reader 110 and an author 112, it is to be appreciated that some users are more prominently an author 112. For instance, celebrities, sports stars, enterprise entities, and so forth, often use social media platforms as a means of promotion. Such entities typically have many followers (e.g., readers 110) on the social media platforms 106 that consume posted content. Thus, such entities may be considered authors 112 for purposes of discussion herein. This is not intended to be limiting, however, and any user that posts content to the social media platforms 106 can be considered an author 112.

According to various embodiments, the social media users 108 (e.g., authors 112) may post content to the social media platforms 106 that identifies a particular brand, which is referred to herein as “brand-related social media content.” Based on various attributes of posted content (e.g., sentiment-related keywords), a brand sentiment can be determined for the content. The brand sentiment, for example, can be positive, negative, or neutral. For instance, a social media user 108 may post content indicating that the user has an affinity for a particular brand (e.g., a positive sentiment), or that the user dislikes a particular brand, e.g., a negative sentiment. As detailed below, techniques discussed herein can be leveraged to correlate user sentiment for a particular brand with other factors to determine a “brand score” for the user.

The social analysis service 102 includes various functionalities that are leveraged to perform techniques discussed herein. For instance, a social data agent 114 represents functionality to detect various social media events, and to collect social media data 116 for the social analysis service 102. For instance, the social media data 116 can be pulled by the social data agent 114 from the social media platforms 106, and/or pushed to the social data agent 114 by the social media platforms 106.

The social media data 116 can include various types of data, such as identifiers for the social media users 108, content posted to the social media platforms 106, geographic region identifiers associated with posted content, keywords extracted from posted content, keywords provided by users in advance, and so on. For instance, consider that one of the social media users 108 posts a comment via a smartphone to one of the social media platforms 106. The comment identifies (e.g., tags) a particular restaurant, and includes the phrase “Food here is excellent!” The social media data 116 extracted from the comment can include a username for the user (e.g., the user's social media handle), a name for the restaurant (e.g., its “brand”), geographic information for the restaurant (e.g., GPS coordinates), keywords extracted from the comment (e.g., “food,” “excellent”), and so forth. Thus, the social media data 116 from the comment can indicate that the particular user has a positive sentiment for the restaurant's brand. According to embodiments discussed herein, the social media data 116 may be utilized to calculate a brand score for the user.

The social media data 116 includes user profiles 118, which are representative of collections of information for the social media users 108. For instance, a particular user may have multiple social media accounts with the different social media platforms 106. The particular user may also use different handles (e.g., usernames) for one or more of the social media platforms 106. According to various embodiments, the user profiles 118 can include an identifier for the user that correlates the multiple social media accounts and/or multiple different handles to a single user.

Various other types of data can be tracked via the user profiles 118, such as user preferences, user history (e.g., historic posts from the social media platforms 106), groups of other users known to interact with a particular user (e.g., “followers”), and so forth. As further detailed below, the user profiles 118 further include various scores, categorizations, and rankings for users, such as brand scores for particular brands and for particular users determined according to techniques discussed herein.

The social analysis service 102 includes various functionalities for managing and processing the social media data 116. For instance, the social analysis service 102 includes a data extraction module 120 and a scoring module 122. The data extraction module 120 is representative of functionality to extract and identify various attributes of the social media data 116. For instance, the data extraction module 120 can parse the social media data 116 to identify keywords (e.g., brand names), sentiment information (e.g., likes/dislikes associated with particular brands), geographical information (e.g., geographical coordinates for posts), and so on. The scoring module 122 is representative of functionality to apply various metrics and logic to attributes of the social media data 116 (e.g., as extracted by the data extraction module 120) to perform techniques for brand scoring for social media users discussed herein. Further operations and implementation details for the scoring module 122 are discussed below.

The social analysis service 102 further includes an input/output (I/O) module 124, which is representative of functionality to receive various types of input and provide various types of output. For instance, the I/O module 124 can receive user input to interact with the scoring module 122, such as to configure various parameters for tracking and scoring the social media users 108 according to techniques discussed herein.

A user interface module 126 is further included, which is representative of functionality to manage various aspects of graphical user interfaces discussed herein. For instance, the user interface module 126 can operate in conjunction with the I/O module 124 to output various information related to the social media data 116 as processed by the data extraction module 120 and/or the scoring module 122. The user interface module 126 may also provide interactive interfaces via which a user can provide input to configure various parameters and processes discussed herein, examples of which are discussed below.

Further to techniques discussed herein, a graphical user interface (GUI) 128 is displayed, such as by the social analysis service 102. The GUI 128 indicates a brand score “84” for a social media user “Chhaya1” and for a particular brand “Acme.” Details concerning how the brand score is calculated are presented below.

The environment 100 further includes one or more networks 130 via which various entities of the environment 100 may communicate. The network(s) 130 may assume a variety of different configurations, such as a local area network (LAN), a wide area network (WAN), the Internet, and so on. In at least some embodiments, functionalities discussed with reference to the environment 100 and/or other portions of the discussion herein may be implemented in a distributed environment (e.g., “over the cloud”), as further described in relation to FIG. 7.

Having described an example environment in which the techniques described herein may operate, consider now a discussion of some example procedures in accordance with one or more embodiments.

Example Procedures

The following section presents some example procedures for performing various aspects of the techniques for brand scoring for social media users discussed herein.

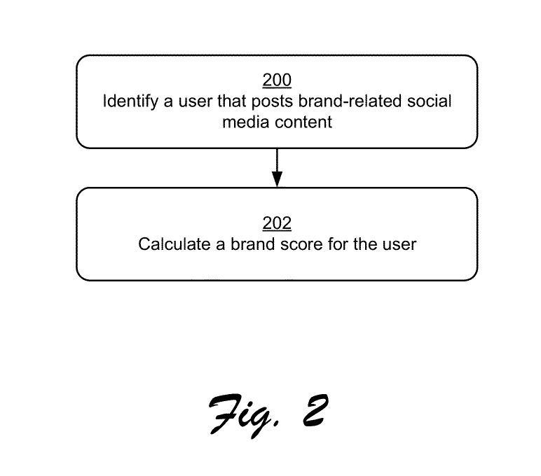

FIG. 2 is a flow diagram that describes steps in a method in accordance with one or more embodiments. The method, for instance, describes a general example way of calculating a brand score for a user in accordance with various embodiments.

Step 200 identifies a user that posts brand-related social media content. The user can be identified, for instance, based on keyword analysis from posts by the user to a social media platform that include one or more keywords associated with the brand. An example detailed implementation of step 200 is presented later in the discussion.

Step 202 calculates a brand score for the user. The brand score can be calculated based on various factors, such as an amount of social media activity by the user that is related to the brand, sentiment associated the social media content related to the brand, a relative influence of the user in a social media environment, and so forth. Example ways for calculating a brand score are presented below.

Generally, the brand score provides an indication of whether a user supports a particular brand, has a neutral attitude towards the brand, or is a detractor of the brand. For instance, a relatively high brand score can indicate that a user supports a particular brand, e.g., that the user has a positive brand influence in a social media environment. A low brand score, however, can indicate that a user is a brand detractor, e.g., that the user has a negative influence on the brand in a social media environment.

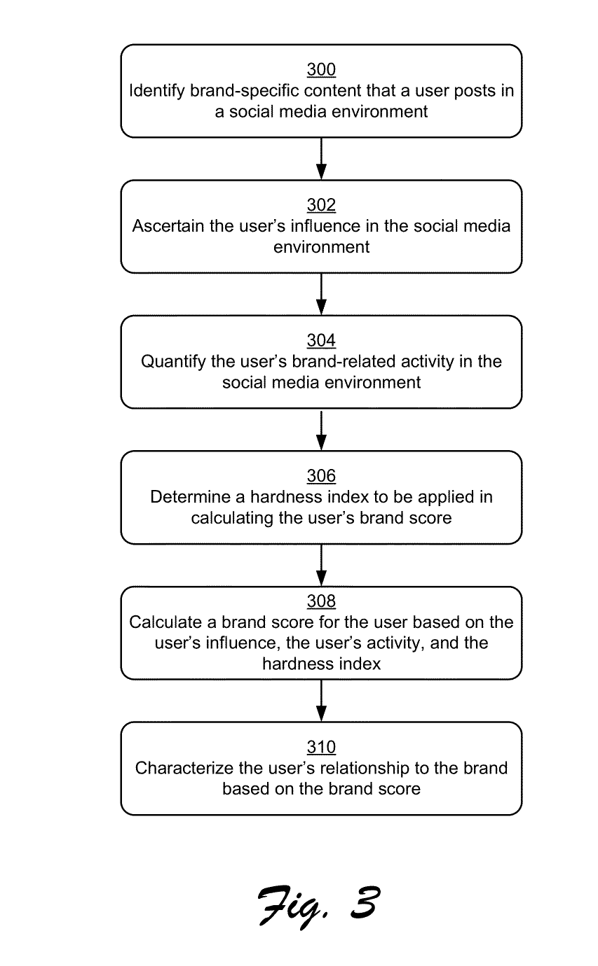

FIG. 3 is a flow diagram that describes steps in a method in accordance with one or more embodiments. The method, for instance, describes a detailed way of calculating a brand score for a user in accordance with various embodiments.

Step 300 identifies brand-specific content that a user posts in a social media environment. The user, for instance, can correspond to a social media handle and/or collection of handles that are correlated to a particular user and/or user profile.

In at least some embodiments, brand-specific content can be identified by detecting particular keywords and/or key phrases that are posted to a social media platform and/or collection of social media platforms. For example, a set of keywords can be pre-specified for a particular brand. The keywords may include the brand name as well as words related to goods and/or services associated with the brand. For instance, for a brand “Acme” that manufactures cameras, keywords may include “Acme,” “camera,” “photography,” “resolution,” and so forth.

Step 302 ascertains the user's influence in the social media environment. A user's influence can be ascertained in various ways, such as based on a number of followers and/or subscribers that the user has on different social media platforms, how much positive sentiment is associated with the user (e.g., how many “likes” the user has), how much of the user's generated content is re-shared by other users, and so forth. In at least some embodiments, user influence can be quantified based on such criteria as an “influence score.”

While some embodiments may calculate an influence score for a user based on various criteria, embodiments may additionally or alternatively obtain an influence score from a 3^{rd}-party service that utilizes various social media analytics to calculate an influence score for a user.

Step 304 quantifies the user's brand-related activity in the social media environment. For instance, an “activity map” can be generated that considers various types of brand-related user activity across one or multiple social media platforms. Detailed examples of quantifying brand-related user activity are presented later in the discussion.

Step 306 determines a hardness index to be applied in calculating the user's brand score. Generally, a hardness index corresponds to a value that can be applied to skew a brand score towards a desired value.

Step 308 calculates a brand score for the user based on the user's influence, the user's activity, and the hardness index. For instance, a brand score can be calculated utilizing values for each of the factors.

While the method described above is discussed as utilizing a particular collection of factors, it is to be appreciated that one or multiple of the factors may be omitted in calculating the brand score for the user. Further, other factors referenced herein and/or not expressly referenced herein may be considered in calculating a brand score.

Step 310 characterizes the user's relationship to the brand based on the brand score. For instance, the brand score can indicate whether the user is a brand supporter, a brand detractor, or has a neutral relationship with the brand. In at least some embodiments, these categories can be pre-specified such that a user can be automatically categorized based on their brand score.

A threshold brand score, for example, can be specified. If a brand score for the user exceeds the threshold brand score, the user may be considered a brand supporter that has a positive influence on perception of the brand in a social media environment. If a brand score for the user falls below the threshold brand score, the user may be considered a brand detractor that has a negative influence on perception of the brand in a social media environment. If a brand score for the user coincides with the threshold brand score or falls within a certain percentage (e.g. +/−5%) of the threshold brand score, the user may be considered to have a neutral influence on perception of the brand in a social media environment.

In at least some embodiments, users may be clustered and/or classified based on their respective brand scores. For instance, users for a top N % (e.g., top 10%) of brand scores may be classified as top promoters for the brand. Top promoters, for example, can be offered an opportunity to engage in brand-promotion activities, such as via offers for free brand-related products and/or services, product and/or service ratings, and so forth.

As another example, users for a bottom N % (e.g., bottom 10%) of brand scores may be classified as top detractors for the brand. Top detractors, for instance, may be offered an opportunity to engage in brand-improvement activities. Such brand improvement activities may include feedback sessions where users may point out flaws in a product and/or service, may suggest ways to improve a product and/or service, and so forth.

Thus, brand score clusters may be leveraged to manage brand perception in a social media environment and beyond.

According to one or more embodiments, users may be ranked based on their respective brand scores. Based on their rankings, top promoters, top detractors, and so forth, may be identified for further brand-related activities, examples of which are referenced above.

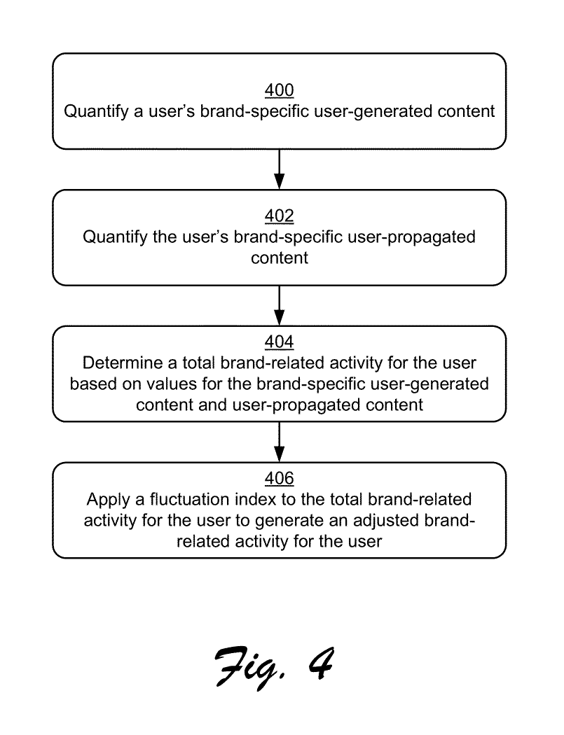

FIG. 4 is a flow diagram that describes steps in a method in accordance with one or more embodiments. The method, for instance, describes a detailed way of quantifying a user's brand-related activity, such as discussed above with reference to step 304 of FIG. 3.

Step 400 quantifies a user's brand-specific user-generated content. According to one or more embodiments, user-generated content refers to content that is originated by a user in a social media environment, e.g., not content that is originated by a different user in the social media environment. User-generated brand-specific content can be quantified, for example, based on a number of brand-specific posts by the user. An example way of quantifying brand-specific user-generated content is discussed below.

Step 402 quantifies the user's brand-specific user-propagated content. According to one or more embodiments, user-propagated content refers to content from another user (e.g., user-generated content from another user) that a user reposts in a social media environment. User-propagated brand-specific content can be quantified, for example, based on a number of brand-specific posts by the user. An example way of quantifying brand-specific user-propagated content is discussed below.

Step 404 determines a total brand-related activity for the user based on values for the brand-specific user-generated content and user-propagated content. For instance, values determined at steps 400 and 402 can be added and/or processed in various ways to determine to total brand-related activity for the user.

Step 406 applies a fluctuation index to the total brand-related activity for the user to generate an adjusted brand-related activity for the user. A fluctuation index, for instance, considers how frequently and/or how recently a user posts brand-related content in the social media environment. For example, a fluctuation index can be utilized to give a higher weight to more recent brand-related posts than to older brand-related posts. In at least some embodiments, a fluctuation index may give more weight to more frequent brand-related user activity than to sporadic brand-related user activity. A detailed example of calculating a fluctuation index is presented below.

Having discussed some example procedures, consider now a discussion of example detailed implementations for calculating a brand score for users in accordance with one or more embodiments.

Calculating Brand Score

The following discussion describes example techniques for calculating a brand score in accordance with one or more embodiments. The example techniques may be implemented via the environment 100 of FIG. 1, the system 700 of FIG. 7, and/or any other suitable environment. The example equations below present detailed ways of determining various values discussed in the procedures above in accordance with one or more embodiments. In at least some embodiments, the equations may be implemented via computer-executable logic, such as by the social analysis service 102.

In at least some embodiments, the following equation can be used to calculate a brand score for a particular brand and for a particular user at a given point in time:

$$Brand Score = R * ( \frac{1}{1 + {e}^{\frac{IS}{HI}}} - \frac{1}{2} ) \qquad Equation 1$$

The various terms used in Equation 1 are explained hereafter.

Range (R)

R refers to the range of values for a brand score. For purposes of illustration, embodiments discussed herein utilize a range from a low of −100 (negative one hundred) as a lowest possible score, to a high of +100 (positive 100) as a highest possible score. Thus, an R value for this range is 200. This R value is presented for purpose of example only, and a variety of different R values may be employed in accordance with one or more embodiments.

Intermediate Score (IS)

IS refers to an intermediate score that is calculated for a particular user. Generally, an intermediate score considers a user's influence and activity across one or multiple social media platforms. An intermediate score, for example, considers brand-specific activity for a particular user.

In at least some embodiments, brand-specific activity can be divided into two primary categories, user-generated content and user-propagated content. User-generated content generally refers to content that is originated by a user in a social media platform or across multiple social media platforms. User-propagated content generally refers to content from another user (e.g., user-generated content from another user) that a user acts on. For instance, user-propagated content can be content from another user that a user reposts in a social media environment.

The following is an example formula for

calculating IS:

$$IS = IFS * ( \frac{α + β}{{α}^{′} + {β}^{′}} ) * log ( 1 + x ) \qquad Equation 2$$

Before continuing on with Equation 1, the various terms of Equation 2 for calculating an intermediate score are explained:

IFS refers to an influence score for a particular user. Generally, an influence score can be determined based on various factors, such as a number of followers that a user has on different social media platforms, a number of times that user posts on social media, a number of user posts that are shared by other users, and so forth. In at least some embodiments, an IFS value can be obtained from a third-party service that calculates and tracks influence scores for different users across one or multiple social media platforms.

α corresponds to a weight of a collection of brand-specific user-generated content (e.g., posts) across one or multiple social media platforms. The following is an example equation for calculating α:

$$α = {\sum }_{brand specific posts}^{ } ( 1 + ( \# reposts ) ) ( post sentiment value )$$

In Equation 3, “# reposts” refers to a number of times that a particular instance content generated by the user has been reposted by other users. The “post sentiment value” can be determined in various ways. For instance, a post that is determined to have a positive sentiment can be given a sentiment value of 1.0, a post that is determined to have a negative sentiment can be given a sentiment value of −2.0, and a post that is determined to have a neutral sentiment can be given a sentiment value of 0.2. These sentiment values are presented for purpose of example only, and a variety of different sentiment values may be employed in accordance with one or more embodiments.

β corresponds to a weight of a collection of brand-specific user-propagated content (e.g., user reposts) across one or multiple social media platforms. The following is an example equation for calculating β:

$$β = {\sum }_{brand specific reposts}^{ } ( log ( 1 + ( \# original reposts ) ) ( original sentiment value ) \qquad Equation 4$$

In Equation 4, “# of original reposts” refers to a number of times that content that a user reposts (e.g., content originated by another user) is reposted by other users. “Original sentiment value” refers to a sentiment value of an original post that is reposted by a user.

α′ can be calculated with the following equation:

$${α}^{′} = {\sum }_{brand specific posts}^{ } ( 1 + \# reposts ) \qquad Equation 5$$

In Equation 5, “# of reposts” refers to a number of times that originated content from a user is reposted by other users.

β′ can be calculated with the following equation:

$${β}^{′} = {\sum }_{brand specific reposts}^{ } log ( 1 + \# original reposts ) \qquad Equation 6$$

In Equation 6, “# original reposts” refers to a number of times that content that a user reposts (e.g., content originated by another user) is reposted by other users.

Continuing with the discussion of Equation 2 for calculating an intermediate score, (IS), x generally refers to a cumulative brand-specific activity for a user and incorporates a fluctuation index that can be applied to account for a difference between a user who posts about a brand sporadically (e.g., not frequently and/or not on a regular basis) and a user who frequently posts about the brand. The fluctuation index enables more recent user activity for a brand to be weighted higher than older activity for the brand.

x, for instance, can be calculated via the following equation:

$${\sum }_{i = 0 to ( \# time slices - 1 )}^{ } ( user {activity}_{current - i} ) ( {fi}^{i} ) \qquad Equation 7$$

In Equation 7, “# time slices” refers to a specified number of divisions of user activity history over which a score is calculated. For instance, for 12 months of user activity data, a time slice value of 1 month (and thus 12 time slices) can be specified. “User activity” refers to a number of instances of user activity (e.g., posts) for a brand over a particular time slice, e.g., 30 days.

Further to Equation 7, “current-i” refers to a decaying weight that is specified to compensate for older user activity; “fi” refers to a fluctuation decay index which specifies a rate of time decay applied to user activity. For instance, a value of 1/1.4 can be specified for fi such that if there is no user activity for a brand for 5 months (e.g., based on a time slice value of 1 month), a user's score for that brand decays to 0.

In at least some embodiments, the various terms of Equation 7 are user-configurable and can be customized across different brands and/or different data collection periods. For instance, fi can be increased or decreased to increase the rate at which a brand score decays, or the decrease a rate at which a brand score decays. Further, different data periods and different time slice values can be specified.

Thus, Equations 3-7 provide example ways of calculating various terms of an intermediate score, which in turn can be used to calculate an overall user score for brand-related activity. The discussion now returns to the terms of Equation 1 for calculating an overall score for brand-related activity.

Hardness Index (HI)

Generally, a hardness index specifies a default score that is used to adjust calculated brand scores. In at least some embodiments, HI can be specified relative to an R value for Equation 1. For instance, one example equation for determining HI is:

$$HI = \frac{R}{y} , \\ where \\ y = a positive integer . \qquad Equation 8$$

Thus, by determining values for and applying the various expressions of Equation 1 discussed above, a brand score for a particular user and for a particular brand can be determined.

Having discussed some example equations for determining various aspects of a brand score for users, consider now a discussion of some example implementation scenarios in accordance with one or more embodiments.

### Example Implementation Scenarios

The following discussion describes example implementation scenarios in accordance with one or more embodiments. The implementation scenarios include various graphs and user interfaces that demonstrate example characteristics of the techniques for brand scoring for social media users discussed herein.

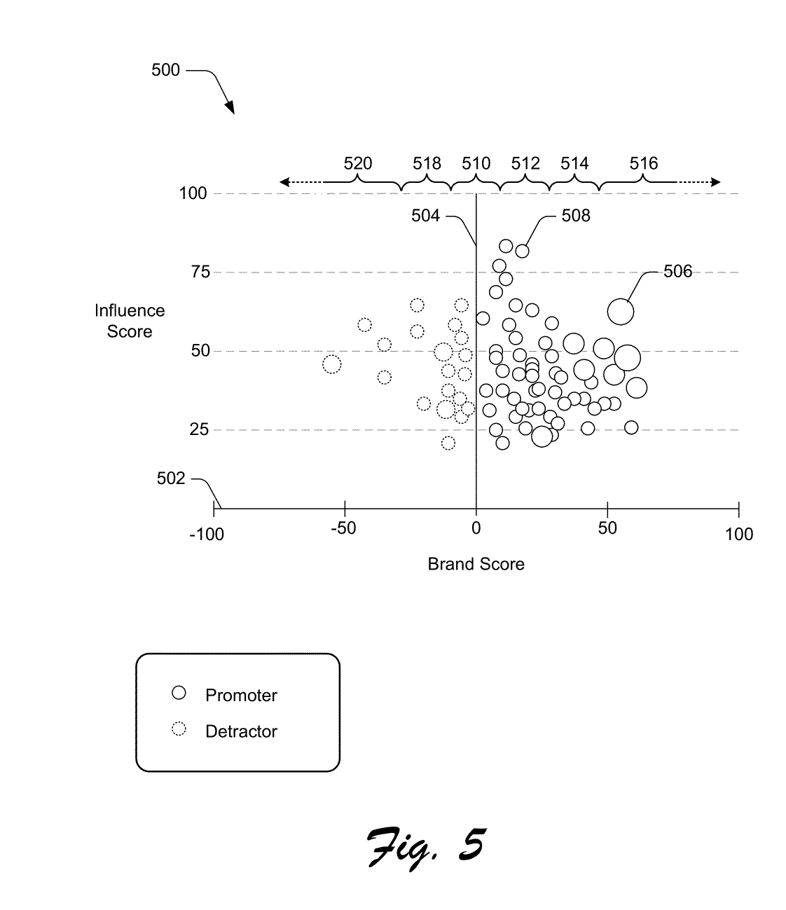

FIG. 5 illustrates an example brand score graph 500 in accordance with one or more embodiments. The brand score graph 500 includes data points illustrated as data bubbles for brand scores calculated for different users according to techniques discussed herein. In at least some embodiments, the brand score graph 500 corresponds to brand scores for particular users and for a particular brand of product and/or service. The brand score graph 500 represents brand-related data collected from a social media environment, such as from a single social media platform or from across multiple social media platforms.

Included as part of the brand score graph 500 is a brand score axis 502 and an influence score axis 504. The brand score axis 502 represents a range of brand score values, such as represented by the R value discussed above. In this example, the brand score values range from a range minimum of −100 to a range maximum +100, thus corresponding to a range of 200. This range of values is presented for purpose of example only, and a variety of different ranges may be employed in accordance with one or more embodiments.

The influence score axis 504 represents a range of influence scores. Example ways of determining and/or obtaining an influence score are discussed above.

The data bubbles illustrated in the brand score graph 500 each represent a different user and/or user profile for which a brand score is calculated. In at least some embodiments, the size of a particular bubble corresponds to an amount of brand-related user activity for a particular user. For instance, a bubble 506 is larger than a bubble 508. Thus, a user associated the bubble 506 may have more and/or more recent brand-related social media activity than a user associated with the bubble 508. Examples of brand-related social media activity are detailed elsewhere herein, and include brand-related user-generated content, brand-related user-propagated content, and so forth.

As discussed above, a user's brand score may be used to characterize the user's relationship to a brand. Thus, in the brand score graph 500, users with a brand score higher than 0 may be considered brand promoters, whereas users with a brand score lower than 0 may be considered brand detractors. As illustrated, brand promoters are illustrated as data bubbles with solid line, whereas brand detractors are illustrated as data bubbles with a dashed line.

As referenced above, users may be categorized based on their respective brand scores. For instance, brand scores may be clustered into different ranges that correspond to different categories of users. The brand score graph 500, for example, includes several score ranges that correspond to different categories of users.

A score range 510, for instance, corresponds to brand neutral users. A score range 512 corresponds to light promoters and a score range 514 corresponds to medium promoters. Still further, a score range 516 corresponds to top promoters of the particular brand.

Looking at the left portion of the brand score graph 500, a score range 518 corresponds to moderate detractors and a score range 520 corresponds to top detractors. As discussed above, categorizing different ranges of brand scores enables various brand-related activities to be targeted to specific groups of users.

In at least some embodiments, the brand score graph 500 is dynamically updateable based on changes in brand score data. For instance, the brand score graph 500 can be updated in real time to reflect brand-related content posted by users to a social media environment.

According to one or more embodiments, detailed brand-related information about social media users can be presented. For instance, consider the following example graphical user interface (GUI).

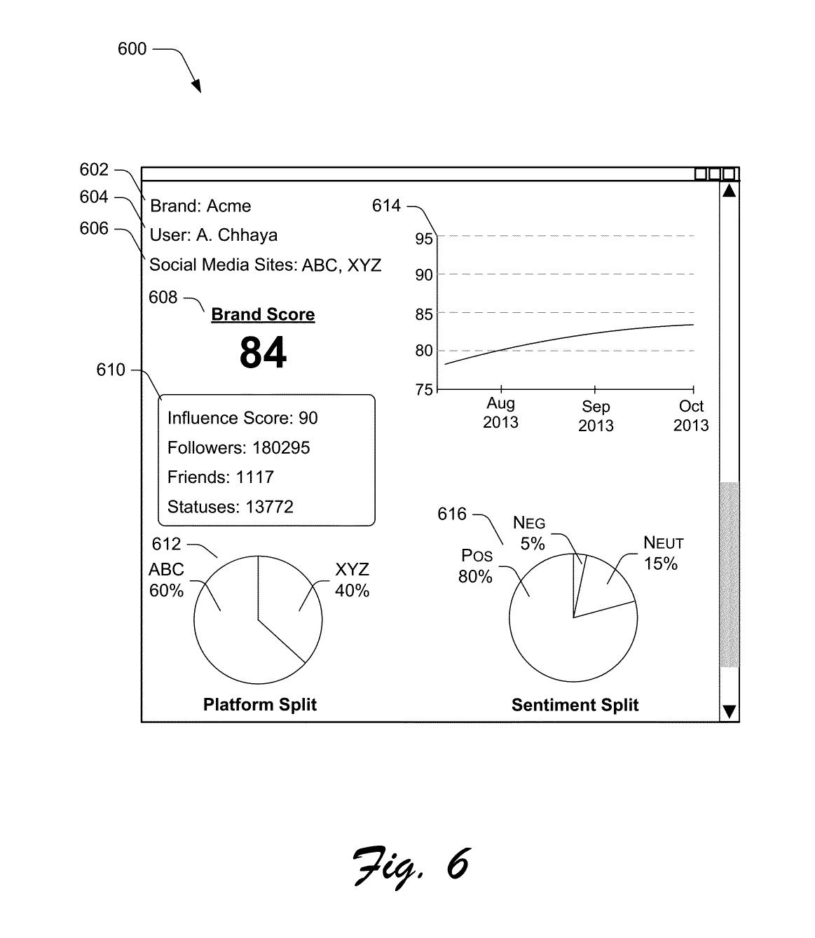

FIG. 6 illustrates an example detail GUI 600 that includes various user details in accordance with one or more embodiments. In at least some embodiments, the detail GUI 600 can be presented in response to a selection of a data bubble from the brand score graph 500. For instance, selection of a data bubble can cause the detail GUI 600 to be presented and populated with data used to calculate a brand score for the user. The detail GUI 600, for example, represents data used to generate one of the data bubbles in the brand score graph 500.

The detail GUI 600 includes a brand field 602 that identifies a brand associated with the detail GUI 600, and a user field 604 that identifies a social media user associated with the detail GUI 600. The detail GUI 600 also includes a platform field 606 that identifies social media platforms (e.g., websites) from which data for the detail GUI 600 was obtained.

A brand score field 608 illustrates a brand score for the social media user, such as calculated via techniques discussed herein. Also illustrated is an influence window 610, which specifies various influence-related data for the social media user. The influence window 610, for instance, displays an influence score, a number of followers, a number of friends, and so forth, for the user.

The detail GUI 600 further includes a platform split chart 612 which illustrates relative distribution of brand-related data obtained from the different social media platforms. For instance, 60% of the data used to generate the brand score 608 was obtained from the social media platform ABC, and 40% of the data was obtained from the social media platform XYZ.

A time graph 614 is also illustrated, which indicates a brand score for the user over time. For instance, the time graph 614 illustrates fluctuations in the user's brand score over a particular time interval. A sentiment split chart 616 illustrates a sentiment distribution for brand-related content posted by the user, e.g., as used to calculate the brand score 608. For instance, the sentiment split chart 616 illustrates that 80% of the user's brand-related posts had a positive sentiment, 15% had a neutral sentiment, and 5% had a negative sentiment.

Thus, the detail GUI 600 presents a detailed illustration of various brand-related attributes for a user. The particular data and modes of illustrating the data presented in the detail GUI 600 are presented for purposes of example only, and a wide variety of other brand-related user data can be illustrated in accordance with one or more embodiments.

Having discussed some example implementation scenarios, consider now a discussion of an example system and device in accordance with one or more embodiments.

Example System and Device

FIG. 7 illustrates an example system generally at 700 that includes an example computing device 702 that is representative of one or more computing systems and/or devices that may implement the various techniques described herein. This is illustrated through inclusion of the social analysis service 102, which may be employed to implement techniques for brand scoring for social media users discussed herein. The computing device 702 may be, for example, a server of a service provider, a device associated with a client (e.g., a client device), an on-chip system, and/or any other suitable computing device or computing system.

The computing device 702 as illustrated includes a processing system 704, one or more computer-readable media 706, and one or more I/O interfaces 708 that are communicatively coupled and/or connected, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 706 are illustrated as including memory/storage 712. The memory/storage 712 represents memory/storage capacity associated with one or more computer-readable media. The memory/storage 712 may include volatile media (such as random access memory (RAM)) and/or nonvolatile media (such as read only memory (ROM), Flash memory, optical disks, magnetic disks, and so forth). The memory/storage 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

Discussed herein are a number of methods that may be implemented to perform techniques discussed herein. Aspects of the methods may be implemented in hardware, firmware, or software, or a combination thereof. The methods are shown as a set of blocks (e.g., steps) that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100, the system 700, and so on.

### CONCLUSION

Techniques for brand scoring for social media users are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A system comprising:
one or more processors; and
one or more computer-readable storage media storing computer-executable instructions that, responsive to execution by the one or more processors, cause the system to perform operations including:
ascertaining an influence score for a user in a social media environment;
quantifying the user's brand-related activity in the social media environment; and
calculating a brand score for the user based on the influence score and the user's brand related activity.

2. A system as described in claim 1, wherein said quantifying is based on a number of brand-related posts by the user to one or more social media platforms.

3. A system as described in claim 1, wherein said quantifying comprises determining a weight of the user's brand-specific user-generated content based at least in part on a number brand-specific posts generated by the user in the social media environment.

4. A system as described in claim 1, wherein said quantifying comprises determining a weight of the user's brand-specific user-propagated content based at least in part on a number of brand-specific user-propagated posts generated by the user in the social media environment.

5. A system as described in claim 1, wherein said quantifying is based at least in part of sentiment values for the user's brand-related activity in the social media environment.

6. A system as described in claim 1, wherein said calculating further comprises applying a fluctuation index that considers how recently the user's brand-related activity occurs.

7. A system as described in claim 1, wherein said calculating further comprises applying a fluctuation index that considers how frequently the user's brand-related activity occurs.

8. A system as described in claim 1, wherein the operations further include ranking the user relative to other users based on respective brand scores for the users.

9. A system as described in claim 1, wherein the operations further include characterizing the user as one of a brand promoter or a brand detractor based on the brand score.

10. A system as described in claim 1, wherein the operations further include displaying a brand score graph that includes a visual indication of the user's brand score and visual indicia for brand scores for other users.

11. A computer-implemented method, comprising:
identifying a user that posts brand-related social media content; and
calculating a brand score for the user based on sentiment values associated with the social media content.

12. A computer-implemented method as recited in claim 11, wherein said calculating is further based on an amount of the brand-related social media content posted by the user.

13. A computer-implemented method as recited in claim 12, wherein the amount of the brand-related social media content posted by the user is determined by:
quantifying the user's brand-specific user-generated content in a social media environment;
quantifying the user's brand-specific user-propagated content in the social media environment; and
determining a total brand-related activity for the user based on values for the brand-specific user-generated content and the brand-specific user-propagated content.

14. A computer-implemented method as recited in claim 11, wherein said calculating is further based on one or more of how frequently or how recently the user posts the brand-related social media content.

15. A computer-implemented method as recited in claim 11, wherein said calculating is further based on an influence score for the user in a social media environment.

16. A computer-implemented method as recited in claim 11, further comprising, based on the brand score, characterizing the user as being one of brand neutral, a brand supporter, or a brand detractor.

17. One or more computer-readable storage media having instructions stored thereon that, responsive to execution by one or more processors, cause the one or more processors to perform operations comprising:
calculating a brand score for a user based on the user's brand-related activity in a social media environment; and
characterizing the user's relationship to the brand based on the brand score.

18. One or more computer-readable storage media as recited in claim 17, wherein said calculating comprises quantifying an amount of the user's brand-related activity in the social media environment.

19. One or more computer-readable storage media as recited in claim 17, wherein said calculating is based on an influence score for the user in the social media environment and sentiment values for the user's brand-related activity in the social media environment.

20. One or more computer-readable storage media as recited in claim 17, wherein said characterizing comprises placing the user into a pre-defined category based on the brand score, the pre-defined category being one of brand neutral, brand supporter, or brand detractor.
